(19) United States
(12) Patent Application Publication
(10) Pub. No.: US 2019/0040637 A1
(43) Pub. Date: Feb. 7, 2019

(54) MODULAR SCAFFOLD

(71) Applicant: CSAHTO OY, PORI (FI)

(72) Inventor: Erik AHTO, Espoo (FI)

(73) Assignee: CSAHTO OY, PORI (FI)

(21) Appl. No.: 16/078,150

(22) PCT Filed: Jan. 17, 2017
(86) PCT No.: PCT/FI2017/050018

§ 371 Date: Aug. 21, 2018

(30) Foreign Application Priority Data
Feb. 24, 2016 (FI) U20164041

(51) Int. Cl. E04G 1/06; E04G 1/15; E04G 5/04; E04G 5/10; E04G 5/14; B33Y 80/00

(52) U.S. Cl. CPC E04G 1/06; E04G 1/153; E04G 5/046; B33Y 80/00; E04G 5/144; E04G 5/145; E04G 5/10

(57) ABSTRACT

A modular scaffold, which includes parts to be joined to each other, which parts are at least standards, ledgers, working platforms and the necessary railings, and also ladders. The parts of the modular scaffold are fabricated mainly from plastic and/or fiber composite.

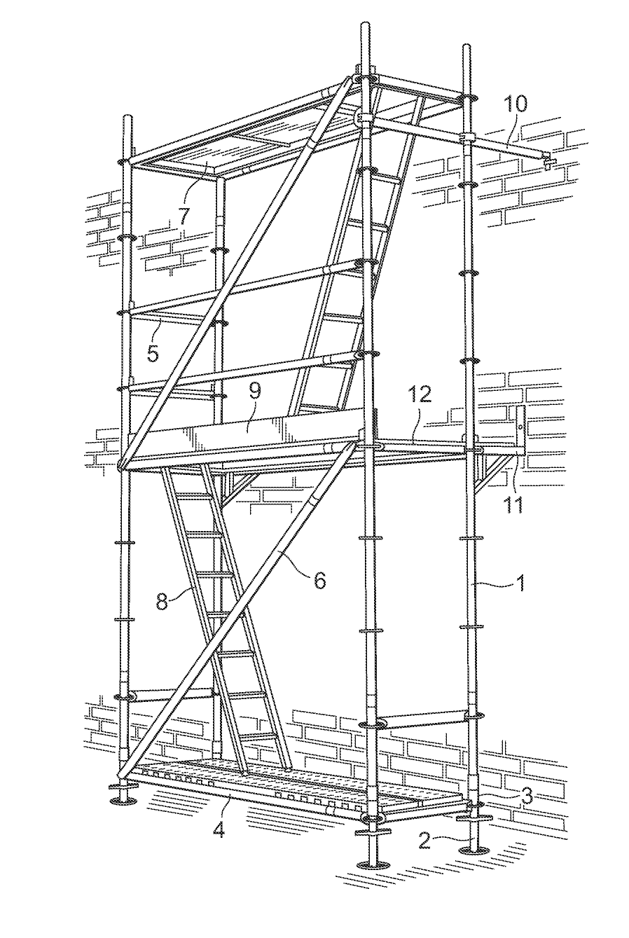

The object of the present invention is a modular scaffold, which comprises parts to be joined to each other, which parts are at least standards, ledgers, working platforms and the necessary railings, and also ladders.

The invention thus relates to so-called modular scaffolds that are used on buildings and can be assembled and disassembled. They comprise, inter alia, standards, ledgers, diagonal braces, working platforms and ladders. Scaffolds can be assembled to be the height and width of a wall of a building by fixing the necessary amount of parts one above another and one beside another. The scaffolds must also be fixed to the all at certain intervals, to ensure that they remain upright.

Modular scaffolds intended for professional use are fabricated mainly from steel. With this, sufficient strength is achieved at reasonable manufacturing costs. A problem with steel, however, is its weight. The parts are heavy and installation attitudes awkward, and this easily causes skeletal and muscular problems resulting in sick leave and even early retirement.

This problem can be alleviated by fabricating the parts mainly from aluminium, in which case the parts weigh considerably less and are easier to handle. A problem with aluminium is, however, its expensive price. For this reason aluminium has not become more widely used as a material for scaffolds.

The aim of the present invention is to provide a modular scaffold to which the aforementioned problems are not attached. The modular scaffold according to the invention is characterized in that the parts of the modular scaffold are fabricated mainly from plastic and/or fiber composite.

One preferred embodiment of the modular scaffold according to the invention is characterized in that the fiber of the fiber composite is one or more of the following: wolfram, steel, glass fiber, carbon fiber, aramid fiber, other polymer fibers, boron fiber, graphite fiber, ceramic fibers (whiskers) and resin.

Another preferred embodiment of the modular scaffold according to the invention is characterized in that the fibers of the fiber composite are mixed into the plastic material.

Yet another preferred embodiment of the modular scaffold according to the invention is characterized in that at least some of the parts of the modular scaffold are fabricated by 3D printing.

The modular scaffold fabricated from plastic material and composite material imitates one fabricated from steel in the principles of its use and in its manner of installation. The main fastening of parts is by cotter joint and the working platforms are clamped with various clamps. A standard is provided with horizontal rings, from which it is possible to connect parts at eight different angles using cotter joints. One aim for the machinability and manufacturing technology of the material is to enable troublefree fabrication also of parts deviating from standard dimensions.

One of the advantages of the invention that can be mentioned is that fiber composite is a lightweight material. A lower weight by volume offers the opportunity of considerably more ergonomic working conditions for scaffolding fitters. For example, the weight of a standard made of steel three meters in length is 15 kg, but when fabricated from fiber composite only e.g. 2-4 kg. In addition to this, scaffolds fabricated from a material according to the invention produce considerably less stress on the base on which they stand and on the support structures on which they are installed. All this considerably increases the opportunities for creating safer working conditions for both scaffolding fitters and people working on scaffolding.

The inherently long service life of a modular scaffold and its main idea of providing a temporary working platform or walkway also means that the material is used at the site for the duration until the scaffold is disassembled and re-assembled somewhere else. Consequently, the journeys made to move scaffold parts, e.g. by truck, are reduced because the lightweight parts can be moved in larger loads. Transferring the material thus places less strain on road traffic and the road network less.

In the following, the invention will be described in more detail by the aid of some preferred embodiments with reference to the attached drawing, which presents an assembled modular scaffold.

The structure of a scaffold is per se known in the art and it comprises standards 1, to which are fastened ledgers/guardrails 4. Adjustable jacks 2 functioning as the lowest part of the scaffold are placed against the ground or against some other base, and base collars 3 are affixed to the jacks. The transoms/endrails are marked with the reference number 5 and the diagonal braces with the reference number 6. A working platform 7 is installed resting on the ledgers 4 and transoms 5. Ladders 8 are installed between the working platforms 7, which ladders enable climbing from one working platform to another. A scaffold can be further provided with toe boards 9.

The modular scaffold is fixed to the wall at certain intervals with ties 10. The figure also presents a bracket 11 and a platform clamp 12.

The structure of the modular scaffold according to the invention can thus be, per se, known in the art. The invention relates to the material of the scaffold, which is plastic or fiber composite. One or more of the following, for example, can be used as the fiber material of the fiber composite. wolfram, steel, glass fiber, carbon fiber, aramid fiber (Kevlar), other polymer fibers, boron fiber, graphite fiber, ceramic fibers (whiskers) and resin. The fiber composite according to the invention is obtained by mixing one/some of the aforementioned fibers into the plastic material.

The parts of the scaffold can be fabricated at the factory or they can be fabricated by 3D printing e.g. at the installation site of the scaffolding, in which case transportation of the parts to the installation site is completely omitted.

It is obvious to the person skilled in the art that the invention is not limited to the embodiments presented above, but that it can be varied within the scope of the claims presented below. Parts fabricated from plastic or fiber composite must, of course, meet all the strength properties required of scaffolding components.

At least most of the parts of a modular scaffold are fabricated from plastic and/or fiber composite. It is possible that some parts are also fabricated from conventional materials.

The modular scaffold presented in the figure is only one example of a scaffold meant by the invention. It can, of course, be of another shape and wider/narrower or higher/lower. What is essential is the modular structure, i.e. that it is assembled from parts at the construction site and it can be disassembled after use and transferred to a new location. A scaffold will comprise at least standards 1, ledgers 4, working platforms 7, railings 4, 5 and ladders 8.

The characteristic features possibly presented in the description in conjunction with other characteristic features can also, if necessary, be used separately to each other.

1. A modular scaffold, comprising:
parts to be joined to each other, said parts being at least standards, ledgers, working platforms, railings, and ladders,
wherein the parts are fabricated mainly from plastic and/or fiber composite.

2. The modular scaffold according to claim 1, wherein the fiber of the fiber composite is one or more of the following: wolfram, steel, glass fiber, carbon fiber, aramid fiber, other polymer fibers, boron fiber, graphite fiber, ceramic fibers (whiskers) and resin.

3. The modular scaffold according to claim 2, wherein the fibers of the fiber composite are mixed into the plastic material.

4. The modular scaffold according to claim 1, wherein at least some of the parts of the modular scaffold are fabricated by 3D printing.

5. The modular scaffold according to claim 2, wherein at least some of the parts of the modular scaffold are fabricated by 3D printing.

6. The modular scaffold according to claim 3, wherein at least some of the parts of the modular scaffold are fabricated by 3D printing.
